(19) United States
(12) Patent Application Publication
(10) Pub. No.: US 2025/0365600 A1
(43) Pub. Date: Nov. 27, 2025

(54) INFORMATION TRANSCEIVING METHOD AND APPARATUS

(71) Applicant: FUJITSU LIMITED, Kawasaki-shi (JP)

(72) Inventors: Gang SUN, Beijing (CN); Jian ZHANG, Beijing (CN)

(73) Assignee: FUJITSU LIMITED, Kawasaki-shi (JP)

(21) Appl. No.: 19/293,084

(22) Filed: Aug. 7, 2025

Related U.S. Application Data
(63) Continuation of application No. PCT/CN2023/075046, filed on Feb. 8, 2023.

(51) Int. Cl. H04W 24/10; H04L 27/26

(52) U.S. Cl. CPC H04W 24/10; H04L 27/26025; H04L 27/261

(57) ABSTRACT

An apparatus, applicable to a network device, includes: a transmitter configured to transmit candidate configuration information for layer 1 or layer 2 (L1/L2) trigger mobility to a terminal equipment, the candidate configuration information at least comprising relevant information of one or more configurations for candidate cell(s); and a receiver configured to receive a measurement report for one or more cell(s) included in the candidate cell(s) transmitted by the terminal equipment.

### CROSS-REFERENCE TO RELATED APPLICATION

This application is a continuation application under 35 U.S.C. 111 (a) of International Patent Application PCT/CN2023/075046 filed on Feb. 8, 2023, and designated the U.S., the entire contents of which are incorporated herein by reference.

### TECHNICAL FIELD

This disclosure relates to the field of communication technologies.

### BACKGROUND

Mobility management is an essential mechanism in cellular mobile communication systems, which may assist new radio NR systems in achieving load balancing, providing users with better experiences, and improving overall system performance. When a terminal equipment moves from a coverage area of a cell to a coverage area of another cell, it is necessary to switch a serving cell of the terminal equipment.

Currently, switch of a serving cell of a terminal equipment is triggered via layer 3 measurement and achieved by reconfiguring the serving cell through radio resource control RRC signaling. When RRC signaling reconfigures the serving cell, operations of layer 1 and layer 2 of the communication system need to be reset, thereby resulting in a relatively large system delay, signaling load and a relatively long communication interruption time. Therefore, it is proposed to trigger via layer 1 measurement results and switch the serving cell via the layer 1/layer 2 signaling, which may effectively reduce system delay, signaling load and communication interruption time.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In current communication standards, in order to support measurement of L1/L2 triggered mobility, corresponding solutions have been proposed for layer 1 measurement of intra-frequency neighboring candidate cells based on synchronization signal blocks (SSBs). Currently, there is no corresponding solution for switch of inter-frequency neighboring candidate cells based on reference signals, nor for layer 1 measurement of intra-frequency neighboring candidate cells based on CSI-RSs, in other words, there is no corresponding solution for layer 1 measurement of neighboring candidate cells based on CSI-RSs.

In order to solve at least one of the above problems, embodiments of this disclosure provide an information transceiving method and apparatus.

According to one aspect of the embodiments of this disclosure, there is provided an information transceiving apparatus, applicable to a network device, the apparatus including:
a first transmitting unit configured to transmit first relevant information of an inter-frequency neighboring candidate cell for layer 1 measurement based on a reference signal to a terminal equipment; and
a first receiving unit configured to receive a measurement report for one or more cell(s) included in the candidate cell(s) transmitted by the terminal equipment.

According to another aspect of the embodiments of this disclosure, there is provided an information transceiving apparatus, applicable to a terminal equipment, the apparatus including:
a second receiving unit configured to receive first relevant information of an inter-frequency neighboring candidate cell for layer 1 measurement based on a reference signal transmitted by a network device; and
a second transmitting unit configured to transmit a measurement report for one or more cell(s) included the candidate cell(s) to the network device.

According to a further aspect of the embodiments of this disclosure, there is provided a communication system, including a terminal equipment and/or a network device, the terminal equipment including the information transceiving apparatus described in the one aspect described above, and the network device including the information transceiving apparatus in the other aspect described above.

An advantage of the embodiments of this disclosure exists in that by configuring the terminal equipment with the first relevant information of an inter-frequency neighboring candidate cell for layer 1 measurement based on a reference signal, layer 1/layer 2 triggered mobility of inter-frequency neighboring candidate cells may be supported, thereby triggering via the layer 1 measurement results, and performing switch of serving cells via layer 1/layer 2 signaling, which may effectively reduce latency of the system, signaling load and communication interruption time.

Another advantage of the embodiments of this disclosure exists in that by configuring the terminal equipment with third relevant information of neighboring candidate cell for layer 1 measurement based on CSI-RSs, layer 1/layer 2 triggered mobility of neighboring candidate cells based on CSI-RSs may be supported, thereby triggering via the layer 1 measurement results, and performing switch of serving cells via layer 1/layer 2 signaling, which may support synchronization with higher precision and higher received signal to noise ratio after the switch, thereby further reducing latency of the system, signaling load and communication interruption time.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/include/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiments of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of embodiments of this disclosure;

FIG. 2 is a schematic diagram of an information transceiving method of embodiments of this disclosure;

FIG. 3 is a schematic diagram of an information transceiving method of embodiments of this disclosure;

FIG. 4 is a schematic diagram of a cell switch method of embodiments of this disclosure;

FIG. 5 is a schematic diagram of an information transceiving method of embodiments of this disclosure;

FIG. 6 is a schematic diagram of an information transceiving method of embodiments of this disclosure;

FIG. 7 is a schematic diagram of a cell switch method of embodiments of this disclosure;

FIG. 8 is a schematic diagram of an information configuration method of embodiments of this disclosure;

FIG. 9 is a schematic diagram of an information transceiving apparatus of embodiments of this disclosure;

FIG. 10 is a schematic diagram of an information transceiving apparatus of embodiments of this disclosure;

FIG. 11 is a schematic diagram of an information transceiving apparatus of embodiments of this disclosure;

FIG. 12 is a schematic diagram of a network device of embodiments of this disclosure; and

FIG. 13 is a schematic diagram of a terminal equipment of embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G new radio (NR) and 6G in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” may refer to a network device, and may also refer to a terminal equipment.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, higher-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

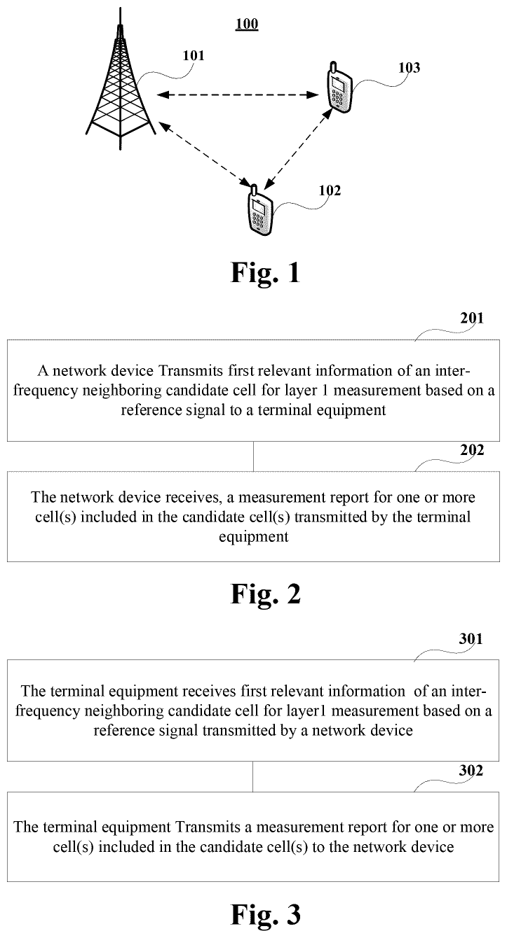

FIG. 1 is a schematic diagram of a communication system of embodiments of this disclosure, in which a case where terminal equipments and a network device are taken as examples is schematically shown. As shown in FIG. 1, the communication system 100 may include a network device 101 and terminal equipments 102, 103. For the sake of simplicity, an example having only two terminal equipments and one network device is schematically given in FIG. 1; however, the embodiments of this disclosure are not limited thereto.

In the embodiments of this disclosure, existing services or services that may be implemented in the future may be performed between the network device 101 and the terminal equipments 102, 103. For example, such services may include but not limited to an enhanced mobile broadband (eMBB), massive machine type communication (mMTC), and ultra-reliable and low-latency communication (URLLC), etc.

The terminal equipment 102 may transmit data to the network device 101, such as in a granted or grant-free transmission manner. The network device 101 may receive data transmitted by one or more terminal equipments 102 and feed back information to the terminal equipment 102, such as acknowledgement (ACK)/non-acknowledgement (NACK) information. According to the feedback information, the terminal equipment 102 may acknowledge end of a transmission process, or may perform new data transmission, or may perform data retransmission.

It should be noted that FIG. 1 shows that two terminal equipments 102, 103 are both in coverage of the network device 101. However, this disclosure is not limited thereto, and the two terminal equipments 102, 103 may not be in coverage of the network device 101, or one terminal equipment 102 is in coverage of the network device 101 and the other terminal equipment 103 is out of coverage of the network device 101.

In a communication protocol stack, there are three layers, in which layer 1 includes a physical layer, layer 2 includes a radio link control (RLC) layer and a media access control (MAC) layer, and layer 3 includes an RRC layer.

Currently, when a reference signal is a synchronization signal block (SSB), corresponding information of intra-frequency neighboring candidate cells is configured in configuration of a synchronization signal block used for layer 1 measurement. Synchronization signal block measurement resource configuration may be expressed as follows by using an ASN.I syntax:

-- ASN1START
-- TAG-CSI-SSB-RESOURCESET-START

| | |
|---|---|
| CSI-SSB-ResourceSet | SEQUENCE { |

::=

| | |
|---|---|
| csi-SSB-ResourceSetId | CSI-SSB-ResourceSetId, |
| csi-SSB-ResourceList | SEQUENCE (SIZE(1..maxNrofCSI- |

```
SSB-ResourcePerSet)) OF SSB-Index,
  ...,
  [[
```

| | |
|---|---|
| servingAdditionalPCIList-r17 | SEQUENCE (SIZE(1..maxNrofCSI- |

SSB-ResourcePerSet)) OF ServingAdditionalPCIIndex-r17
OPTIONAL -- Need R
]]
}

| | |
|---|---|
| ServingAdditionalPCIIndex-r17 ::= | INTEGER(0..maxNrofAdditionalPCI- |

r17)
-- TAG-CSI-SSB-RESOURCESET-STOP
-- ASN1STOP

That is, a servingAdditionalPCIList-r17 information field is added to the synchronization signal block measurement resource configuration information, and is associated with SSBs in an SSB set, with contents therein being a physical cell ID index of an intra-frequency neighboring candidate cell. When a value thereof is 0, it indicates that the reference signal is a reference signal of a current serving cell, and when the value is not 0, it is AdditionalPCIIndex-r17, indicating that the reference signal is a reference signal of the intra-frequency neighboring candidate cell.

In addition, the value AdditionalPCIIndex-r17 of the physical cell ID index of the intra-frequency neighboring candidate cell is configured in a SSB measurement timing configuration information element (SSB-MTC), which may be expressed as follows by using an ASN.I syntax:

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, |
| | ms10, ms20, |

ms40, ms80, ms160, spare2, spare1 },

| | |
|---|---|
| ssb-PositionsInBurst-r17 | CHOICE { |
| shortBitmap | BIT STRING (SIZE (4)), |
| mediumBitmap | BIT STRING (SIZE (8)), |
| longBitmap | BIT STRING (SIZE (64)) |

},

| | |
|---|---|
| ss-PBCH-BlockPower-r17 | INTEGER (−60..50) |

}
AdditionalPCIIndex-r17 ::= INTEGER(1..maxNrofAdditionalPCI-r17)

That is, an SSB-MTC-AdditionalPCI-r17 information field is added to the measurement timing configuration information element SSB-MTC of the SSBs of the neighboring candidate cell, including the physical cell ID index (AdditionalPCIIndex-r17), a physical cell ID, and such measurement-related parameters as a period of SSB measurement, time-domain positions of the SSBs, and power, etc.

As described above, in order to support measurement of L1/L2 triggered mobility, corresponding solutions have been proposed about the configuration of intra-frequency neighboring candidate cells for layer 1 measurement based on SSBs. Currently, there is no corresponding solution about the configuration of intra-frequency neighboring candidate cells for layer 1 measurement based on CSI-RSs, nor for switch of inter-frequency neighboring candidate cells based on reference signals, in other words, there is no corresponding solution about the configuration of neighboring candidate cells for layer 1 measurement based on CSI-RSs.

In order to solve the above problems, embodiments of this disclosure provide an information transceiving method and apparatus, which shall be described below with reference to the accompanying drawings and embodiments.

### Embodiments of a First Aspect

The embodiments of this disclosure provide an information transceiving method, which shall be described from a network device side.

FIG. 2 is a schematic diagram of the information transceiving method of the embodiments of this disclosure. As shown in FIG. 2, the method includes:
201: a network device transmits first relevant information of an inter-frequency neighboring candidate cell for layer 1 measurement based on a reference signal to a terminal equipment; and
202: the network device receives, a measurement report for one or more cell(s) included in the candidate cell(s) transmitted by the terminal equipment.

It should be noted that FIG. 2 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

With the above embodiments, by configuring the terminal equipment with the first relevant information of an inter-frequency neighboring candidate cell for layer 1 measurement based on a reference signal, switch of layer 1/layer 2 of inter-frequency neighboring candidate cells may be supported, thereby triggering via the layer 1 measurement results, and performing switch of serving cells via layer 1/layer 2 signaling, which may effectively reduce latency of the system, signaling load and communication interruption time.

In some embodiments, the configuration of a neighboring candidate cell for layer 1 measurement based on a reference signal is used to support layer 1/layer 2 triggered mobility, or, in other words, the configuration of a neighboring candidate cell for layer 1 measurement based on a reference signal is used to support layer 1/layer 2 triggered mobility of a neighboring candidate cell, that is, performing switch of a serving cell via layer 1/layer 2 signaling.

In some embodiments, the reference signal includes an SSB or a CSI-RS, the CSI-RS being a CSI-RS for beam management, or a CSI-RS for interference management (CSI-IM), or a CSI-RS for time-frequency tracking (TRS); however, the embodiments of this disclosure are not limited thereto.

In some embodiments, the network device of the serving cell may configure reference signal resources for measurement of a current serving cell and the neighboring cell, that is, the method may include: the network device transmits reference signal measurement resource configuration information for layer 1 measurement to the terminal equipment, the reference signal measurement resource configuration information being carried by RRC signaling. A measurement resource and a reference signal are interchangeable below.

In some embodiments, the configured measurement resources are a resource set list (reference signal set), each resource set consisting of one or more measurement resources (reference signals). The network device may configure the terminal equipment with multiple reference signals for neighboring candidate cell layer 1 measurement. The reference signal measurement resource configuration information includes a reference signal set identifier (measurement resource set identifier), an index/indices of one or more measurement resources (reference signals) constituting the reference signal set (measurement resource set) and indices of cell identifiers associated with each reference signal. In other words, when the reference signal measurement resource configuration information includes the indices of the cell identifiers associated with each reference signal, it indicates that the configured reference signal set is used for measurement of layer 1/layer 2 triggered mobility. The configuration of indices of the cell identifiers correspond one-to-one with the reference signals, wherein that the reference signal is associated with the cell refers to that the reference signal is transmitted by a network device of the associated cell. By adding this association, a cell from which each reference signal in the reference signal set comes may be indicated, and the terminal equipment may perform measurement on the associated cell by measuring quality of the reference signal of the cell. The associated cell includes the current serving cell and/or the neighboring candidate cell, the neighboring candidate cell including an intra-frequency neighboring candidate cell and/or an inter-frequency neighboring candidate cell.

It should be noted that in the following embodiments, names, data types and value ranges of the information fields are illustrative only, and are not intended to limit the embodiments of this disclosure, which shall be exemplified below.

For example, when the reference signals are SSBs, the reference signal measurement resource configuration information CSI-SSB-ResourceSet used for layer 1 measurement may be expressed as follows by an ASN. I syntax (example 1):

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI- |

```
SSB-ResourcePerSet)) OF SSB-Index,
  ...,
  [[
```

| | |
|---|---|
| servingAdditionalPCIList-r17 | SEQUENCE (SIZE(1..maxNrofCSI- |

SSB-ResourcePerSet)) OF ServingAdditionalPCIIndex-r17
OPTIONAL -- Need R
]]
}

| | |
|---|---|
| ServingAdditionalPCIIndex-r17 ::= | INTEGER(0..maxNrofAdditionalPCI- |

r17)
-- TAG-CSI-SSB-RESOURCESET-STOP
-- ASN1STOP

That is, the configuration information includes the reference signal set identifier CSI-SSB-ResourceSetId and indices csi-SSB-ResourceList (SSB INDEX) of the reference signals in the reference signal set, and it further includes the configuration of indices servingAdditionalPCIList-r17 of the cell identifiers associated with the reference signals, values thereof being PCI indices of cells associated with the reference signals, and data type thereof being a sequence of integers (0 or AdditionalPCIIndex-r17), a length of the sequence being the number of reference signals in the reference signal set, and a range of each value in the sequence being dependent on the number of neighboring candidate cells needing to be configured. For example, indices of preconfigured cell identifiers include 0, 1, 2, 3, 4, 5, 6, 7; where, 0 denotes the current serving cell, and 1, 2, 3, 4, 5, 6 and 7 denote neighboring candidate cells. Assuming that the reference signal set includes 64 SSBs and indices of the SSBs are 0, 1, 2 . . . , 63, the indices servingAdditionalPCIList-r17 of the cell identifiers associated with the reference signals include indices of 64 cell identifiers, and an order of arrangement of the indices corresponds to that of the 64 SSBs. For example, 0, 1, 1, 1, 4, 4 . . . indicate that a first SSB is associated with the current serving cell, a second, third and fourth SSBs are associated with neighboring candidate cells with an index 1, a fifth, sixth and seventh SSBs are associated with neighboring candidate cells with an index 4, and so on, which shall not be enumerated herein any further.

For example, when the reference signals are CSI-RSs used for beam measurement, the reference signal measurement resource configuration information NZP-CSI-RS-ResourceSet for layer 1 measurement may be expressed as follows by using an ASN. I syntax (example 2):

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE |
| | (1..maxNrofNZP-CSI-RS- |

ResourcesPerSet)) OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

OPTIONAL, -- Need R
...,

| | |
|---|---|
| servingAdditionalPCIList-r18 | SEQUENCE (SIZE(1.. |
| | maxNrofNZP-CSI- |

| | |
|---|---|
| RS-ResourcesPerSet)) OF AdditionalPCIIndex-r18 | OPTIONAL, |

}
AdditionalPCIIndex-r18 ::= INTEGER(1..maxNrofAdditionalPCI-r18)

That is, the configuration information includes the reference signal set identifier nzp-CSI-ResourceSetId and the indices nzp-CSI-RS-Resources (NZP-CSI-RS-ResourceId) of the reference signals in the reference signal set, and furthermore, an optional information field servingAdditionalPCIList-r18 is added, the reference signals are associated with the configuration of indices of the cell identifiers. When this information field is present, it indicates that the configured reference signal set is used for measurement of layer 1/layer 2 triggered mobility, values thereof being PCI indices of cells associated with the reference signals, and data type thereof being a sequence of integers (0 or AdditionalPCIIndex-r18), a length of the sequence being the number of reference signals in the reference signal set, and a range of each value in the sequence being dependent on the number of neighboring candidate cells needing to be configured. For example, indices of preconfigured cell identifiers include 0, 1, 2, 3, 4, 5, 6, 7; where, 0 denotes the current serving cell, and 1, 2, 3, 4, 5, 6 and 7 denote neighboring candidate cells. Assuming that the reference signal set includes 64 CSI-RS resources and indices of the resources are 0, 1, 2 . . . , 63, the indices servingAdditionalPCIList-r18 of the cell identifiers associated with the reference signals include indices of 64 cell identifiers, and an order of arrangement of the indices corresponds to that of the 64 CSI-RS resources. For example, 0, 1, 1, 1, 4, 4 . . . indicate that a first CSI-RS resource is associated with the current serving cell, a second, third and fourth CSI-RS resources are associated with neighboring candidate cells with an index 1, a fifth, sixth and seventh CSI-RS resources are associated with neighboring candidate cells with an index 4, and so on, which shall not be enumerated herein any further.

Optionally, in the scheme of layer 1/layer 2 cell switch, in order to further reduce switching latency of the system, it is needed to finish estimation of fine synchronization of the neighboring cells before cell switch behaviors occur.

Therefore, when the CSI-RS resources are CSI-RS (TRS) resources used for time-frequency tracking, the reference signal measurement resource configuration information may further include first indication information trs-Info, the first indication information being used to indicate that the reference signals in the reference signal set are used for time-frequency tracking; or in other words, the reference signal set is a TRS set, or in other words, the reference signals are TRSs, which are used for the terminal equipment to perform downlink fine synchronization, that is, the reference signal measurement resource configuration information including the first indication information may be deemed as TRS measurement resource configuration information. The reference signal measurement resource configuration information NZP-CSI-RS-ResourceSet used for layer 1 measurement may be expressed as follows by using an ASN. I syntax (example 3):

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE |
| | (1..maxNrofNZP-CSI-RS- |

ResourcesPerSet)) OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

OPTIONAL, -- Need R
...,

| | |
|---|---|
| servingAdditionalPCIList-r18 | SEQUENCE (SIZE(1.. |
| | maxNrofNZP-CSI- |

RS-ResourcesPerSet)) OF AdditionalPCIIndex-r18
OPTIONAL,
}
AdditionalPCIIndex-r18 ::= INTEGER(1..maxNrofAdditionalPCI-r18)

That is, the TRS measurement resource configuration information includes a TRS set identifier nzp-CSI-ResourceSetId and indices nzp-CSI-RS-Resources (NZP-CSI-RS-ResourceId) of TRSs in the TRS set, and it further includes a newly-added optional information field servingAdditionalPCIList-r18, and when this information field is present, it indicates that the configured reference signal set is used for measurement of layer 1/layer 2 triggered mobility. The information field associates the TRSs with the configuration of indices of the cell identifiers, and values thereof being PCI indices of cells associated with the TRSs. Implementation of servingAdditionalPCIList-r18 is as described above, which shall not be repeated herein any further.

For example, when the reference signals are CSI-RS resources used for interference management (CSI-IM), the reference signal measurement resource configuration information CSI-IM-ResourceSet used for layer 1 measurement may be expressed as follows by using an ASN. I syntax (example 4):

| | |
|---|---|
| CSI-IM-ResourceSet ::= | SEQUENCE { |
| csi-IM-ResourceSetId | CSI-IM-ResourceSetId, |
| csi-IM-Resources | SEQUENCE |
| | (SIZE(1..maxNrofCSI-IM- |

ResourcesPerSet)) OF CSI-IM-ResourceId,

| | |
|---|---|
| servingAdditionalPCIList-r18 | SEQUENCE (SIZE(1.. |
| | maxNrofCSI-IM- |

| | |
|---|---|
| ResourcesPerSet)) OF AdditionalPCIIndex-r18 | OPTIONAL, |

...
}

That is, the configuration information includes a reference signal set identifier csi-IM-ResourceSetId and indices csi-IM-Resources (CSI-IM-ResourceId) of the reference signals in the reference signal set, and it further includes a newly-added optional information field servingAdditionalPCIList-r18, and when this information field is present, it indicates that the configured reference signal set is used for measurement of layer 1/layer 2 triggered mobility. The information field associates the reference signals with the configuration of indices of the cell identifiers. Implementation of servingAdditionalPCIList-r18 is as described above, which shall not be repeated herein any further.

In some embodiments, as described above, the reference signal set configured by the reference signal measurement resource configuration information is used for measurement of layer 1/layer 2 triggered mobility (layer 1/layer 2 switch). Optionally, indication information may be added to the reference signal measurement resource configuration information, which may explicitly indicate that the reference signal set is used for measurement of layer 1/layer 2 triggered mobility (layer 1/layer 2 switch). For example, an indication information field L1/L1-mobility-info may be added to above example 1 or example 2 or example 3 or example 4, its data type being an enumerated type. When the reference signal measurement resource configuration information includes the indication information, it indicates that the configured reference signal set is used for measurement of layer 1/layer 2 triggered mobility (layer 1/layer 2 switch), and configuration information of the neighboring candidate cells needs to be configured at this moment, that is, the information field servingAdditionalPCIList-r18 needs to be configured, or, in other words, the reference signal measurement resource configuration information needs to include the information field servingAdditionalPCIList-r18; otherwise, when the reference signal measurement resource configuration information does not include the indication information, it indicates that the configured reference signal set is not used for measurement of layer 1/layer 2 triggered mobility (layer 1/layer 2 switch).

Taking example 3 as an example, the reference signal measurement resource configuration information NZP-CSI-RS-ResourceSet added with the indication information may be expressed as follows by using an ASN. I syntax:

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE |
| | (1..maxNrofNZP-CSI-RS- |

ResourcesPerSet)) OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

OPTIONAL, -- Need R

| | |
|---|---|
| L1/L2-mobility-info | ENUMERATED {true} |

OPTIONAL,
...,

| | |
|---|---|
| servingAdditionalPCIList-r18 | SEQUENCE (SIZE(1.. |
| | maxNrofNZP-CSI- |

RS-ResourcesPerSet)) OF AdditionalPCIIndex-r18
OPTIONAL,
}
AdditionalPCIIndex-r18 ::= INTEGER(1..maxNrofAdditionalPCI-r18)

Here, example 3 is taken as an example only, and implementations of the indication information in examples 1, 2 and 4 are similar thereto, which shall not be repeated herein any further. It should be noted that the indication information and information field trs-Info are not expected to be configured simultaneously, and the indication information and a repetition information field are also not expected to be configured simultaneously. That is, when the reference signal measurement resource configuration information includes the indication information, the information field trs-Info cannot be included, and a value the repetition cannot be configured as on, i.e. configuration of the repetition may not be included, or, the configuration of the repetition may be included, but it can only be configured as off. When the reference signal measurement resource configuration information includes the information field trs-Info, it cannot include the indication information and the configuration of repetition. When the value of repetition of the reference signal measurement configuration information is on, it cannot include the indication information and the information field trs-Info.

The reference signal measurement resource configuration information is described above, the configuration information indicating a correspondence between the configured reference signals and the configuration of neighboring candidate cells, and the network device may further configure relevant measurement parameters of the reference signals of the neighboring candidate cells (or, in other words, the network device may further configure the neighboring candidate cells), that is, the network device of the serving cell may transmit configuration information for the neighboring candidate cells to the terminal equipment, and the neighboring candidate cells may be intra-frequency neighboring candidate cells or inter-frequency neighboring candidate cells, that is, the configuration information at least includes first relevant information of an inter-frequency neighboring candidate cell for layer 1 measurement based on the reference signals and/or second relevant information (carried by RRC signaling) of an intra-frequency neighboring candidate cell for layer 1 measurement based on the reference signals.

In some embodiments, the first relevant information of an inter-frequency neighboring candidate cell for layer 1 measurement based on the reference signals includes cell identifier information and at least one of a reference signal frequency point and a reference signal subcarrier spacing. The inter-frequency neighboring candidate cells include one or more neighboring cells, and at least one of center frequency points and subcarrier spacings of the inter-frequency neighboring candidate cells and the serving cell are different. For example, for inter-frequency candidate neighboring cells with identical subcarrier spacing and different center frequency points, the first relevant information needs to include cell identifier information and the reference signal frequency point, and the subcarrier spacing is optional; for inter-frequency candidate neighboring cells with different subcarrier spacings and identical center frequency point, the first relevant information needs to include the cell identifier information and reference signal subcarrier spacing, and the center frequency point is optional; and for inter-frequency candidate neighboring cells with different subcarrier spacings and different center frequency points, the first relevant information needs to include the cell identifier information, the reference signal subcarrier spacing and the center frequency point. Therefore, the terminal equipment may determine frequency information of the inter-frequency candidate neighboring cells and associated reference signals. Furthermore, the cell identifier information includes cell identifiers and indices of the cell identifiers. The first relevant information further includes at least one of reference signal measurement periodicity configuration information, reference signal power configuration information, and reference signal time-frequency resource information.

In some embodiments, the second relevant information of the intra-frequency neighboring candidate cell for layer 1 measurement based on reference signals includes cell identifier information, the intra-frequency neighboring candidate cells include one or more neighboring cells, center frequency points and subcarrier spacings of the intra-frequency candidate neighboring cells and the serving cell are identical, and the cell identifier information includes a cell identifier and an index of the cell identifier. The second relevant information further includes at least one of reference signal measurement periodicity configuration information, reference signal power configuration information, and reference signal time-frequency resource information.

In some embodiments, the first relevant information and the second relevant information are carried by an identical information element or information field (such as configuration information for neighboring candidate cells), or by different information elements or information fields. The cell identifier (ID) information of the first relevant information and the cell ID information of the second relevant information are indicated by an identical information element or information field, or by different information elements or information fields, which shall be exemplified below.

For example, when the reference signals are SSBs:

In some embodiments, the first relevant information and the second relevant information are carried by an identical information element or information fields, that is, the relevant information of the intra-frequency neighboring candidate cells for layer 1 measurement and the relevant information of the inter-frequency neighboring candidate cells for layer 1 measurement are mixed together and configured. For example, existing configuration information SSB-MTC-AddintialPCI-r17 for neighboring candidate cells may be used to configure (or carry) the first relevant information and/or the second relevant information, wherein SSB-MTC-AddintialPCI-r17 may be expressed as following by using an ASN. I syntax:

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, ms20, ms40, |

ms80, ms160, spare2, spare1 },

| | |
|---|---|
| ssb-PositionsInBurst-r17 | CHOICE { |
| shortBitmap | BIT STRING (SIZE (4)), |
| mediumBitmap | BIT STRING (SIZE (8)), |
| longBitmap | BIT STRING (SIZE (64)) |

},

| ss-PBCH-BlockPower-r17 | INTEGER (−60..50) | |
|---|---|---|
| ssbFrequency | ARFCN-ValueNR | OPTIONAL, |
| ssbSubcarrierSpacing | SubcarrierSpacing | OPTIONAL, |

AdditionalPCIIndex-r17 ::= INTEGER(1..maxNrofAdditionalPCI-r17)

That is, additionalPCIIndex-r17 and additionalPCI-r17 in the existing SSB-MTC-AddintialPCI-r17 may be reused as the cell identifier information in the first relevant information or the second relevant information, i.e. the index additionalPCIIndex-r17 of the cell ID, and cell ID additionalPCI-r17. SSBs corresponding to additionalPCIIndex-r17 may be found in the indices of the cell identifiers associated with the reference signals in the reference signal measurement resource configuration information. Therefore, with this cell identifier information, the SSBs may be associated with the cell IDs of the (intra-frequency or inter-frequency) neighboring candidate cells, wherein data types of the indices of the cell IDs additionalPCIIndex-r17 are integers, and value ranges thereof are dependent on the number of (intra-frequency or inter-frequency) neighboring candidate cells needing to be configured. Data types (PhysCellId) of additionalPCI-r17 are integers, and value ranges thereof are 0 to 1007. In addition, for the inter-frequency neighboring candidate cells, an information field ssbFrequency of SSB frequency points of the inter-frequency neighboring candidate cells and/or an information field ssbSubcarrierSpacing of SSB subcarrier spacings of the inter-frequency neighboring candidate cells may be added to SSB-MTC-AddintialPCI-r17. Optionally, a SSB measurement periodicity configuration information periodicity-r17, SSB time-domain resource information ssb-PositionsInBurst and SSB power configuration information ss-PBCH-BlockPower-r17 may further be included; where, a value of ssbFrequency is a frequency point index corresponding to a synchronization raster predefined in NR, and a value range thereof is 0˜3279165; a value of ssbSubcarrrierSpacing is a subcarrier spacing predefined in NR, and a numerical value type thereof is an enumerated type. The newly-added information fields ssbFrequency and ssbSubcarrrierSpacing are optional, and when they are present in SSB-MTC-AddintialPCI-r17, it indicates that SSB-MTC-AddintialPCI-r17 carries the first relevant information; otherwise, when they are not present in SSB-MTC-AddintialPCI-r17, it indicates that SSB-MTC-AddintialPCI-r17 carries the second relevant information, that is, when they are present in SSB-MTC-AddintialPCI-r17, it indicates that a cell to which the cell identifier information carried by SSB-MTC-AddintialPCI-r17 corresponds is an intra-frequency neighboring candidate cell; otherwise, when they are not present in SSB-MTC-AddintialPCI-r17, it indicates that a cell to which the cell identifier information carried by SSB-MTC-AddintialPCI-r17 corresponds is an inter-frequency neighboring candidate cell. In this example, the cell ID information of the first relevant information and the cell ID information of the second relevant information are indicated by using an identical information element or information field additionalPCIIndex-r17 and additionalPCI-r17 (existing information elements or information fields are reused).

In some embodiments, the first relevant information and the second relevant information are carried by different information elements or information fields, that is, relevant information of intra-frequency neighboring candidate cell and inter-frequency neighboring candidate cell for layer 1 measurement is separately configured. For example, for the intra-frequency neighboring candidate cells, the existing SSB-MTC-AddintialPCI-r17 may be used to configure the second relevant information, wherein SSB-MTC-AddintialPCI-r17 may be expressed as follows by using an ASN. I syntax:

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, |
| | ms20, ms40, |

ms80, ms160, spare2, spare1 },

| | |
|---|---|
| ssb-PositionsInBurst-r17 | CHOICE { |
| shortBitmap | BIT STRING (SIZE (4)), |
| mediumBitmap | BIT STRING (SIZE (8)), |
| longBitmap | BIT STRING (SIZE (64)) |

},

| | |
|---|---|
| ss-PBCH-BlockPower-r17 | INTEGER (−60..50) |

}
AdditionalPCIIndex-r17 ::= INTEGER(1..maxNrofAdditionalPCI-r17)

SSB-MTC-AddintialPCI-r17 includes (intra-frequency) information field additionalPCIIndex-r17 and information field additionalPCI-r17, and optionally, it may further include SSB measurement periodicity configuration information periodicity-r17, SSB time-domain resource information ssb-PositionsInBurst, and SSB power configuration information ss-PBCH-BlockPower-r17. The above existing information is equivalent to the second relevant information, and SSBs corresponding to additionalPCIIndex-r17 may be found in the indices of the cell identifiers associated with the reference signals in the reference signal measurement resource configuration information. Hence, with this cell identifier information, the SSBs and the cell IDs of the (intra-frequency) neighboring candidate cells may be associated. In addition, value ranges and data types of the information fields are similar to those described in the previous embodiments, which shall not be repeated herein any further.

For the inter-frequency neighboring candidate cells, the first relevant information may be configured by using the newly-added information element SSB-MTC-AddintialPCI-r18, wherein SSB-MTC-AddintialPCI-r18 may be expressed as follows by using an ASN. I syntax:

| | |
|---|---|
| SSB-MTC-AdditionalPCI-r18 ::= | SEQUENCE { |
| additionalPCIIndex-r18 | AdditionalPCIIndex-r18, |
| additionalPCI-r18 | PhysCellId, |
| periodicity-r18 | ENUMERATED { ms5, ms10, ms20, ms40, |

ms80, ms160, spare2, spare1 },

| ssb-PositionsInBurst-r18 | CHOICE { | |
|---|---|---|
| shortBitmap | BIT STRING (SIZE (4)), | |
| mediumBitmap | BIT STRING (SIZE (8)), | |
| longBitmap | BIT STRING (SIZE (64)) | |
| }, | | |
| ss-PBCH-BlockPower-r18 | INTEGER (−60..50) | |
| ssbFrequency | ARFCN-ValueNR | OPTIONAL, |
| ssbSubcarrierSpacing | SubcarrierSpacing | OPTIONAL, |

AdditionalPCIIndex-r18 ::= INTEGER(1..maxNrofAdditionalPCI-r18)

That is, the cell identifier information, namely, (inter-frequency) information field additionalPCIIndex-r18 and information field additionalPCI-r18 (which are different from the information elements or information fields additionalPCIIndex-r17 and additionalPCI-r17 of the cell identifier information in the second relevant information), is added to the newly-added SSB-MTC-AddintialPCI-r18. Furthermore, an information field ssbFrequency of SSB frequency points of inter-frequency neighboring candidate cells and/or an information field ssbSubcarrrierSpacing of SSB subcarrier spacings of inter-frequency neighboring candidate cells may also be added to SSB-MTC-AddintialPCI-r18, and specific implementations thereof are as described above, which shall not be repeated herein any further. Optionally, SSB measurement periodicity configuration information periodicity-r18, SSB time-domain resource information ssb-PositionsInBurst and SSB power configuration information ss-PBCH-BlockPower-r18 may further be included. The above information is taken as the first relevant information, and SSBs corresponding to additionalPCIIndex-r18 may be found in the indices of the cell identifiers associated with the reference signals in the reference signal measurement resource configuration information. Hence, with this cell identifier information, the SSBs and the cell IDs of the (inter-frequency) neighboring candidate cells may be associated. In addition, value ranges and data types of the information fields are similar to those described in the previous embodiments, which shall not be repeated herein any further.

In associating the SSBs above, the intra-frequency neighboring candidate cells and the inter-frequency neighboring candidate cells may respectively be associated with a group of SSBs, that is, SSBs with which additionalPCIIndex-r17 is associated and SSBs with which additionalPCIIndex-r18 is associated are different (in terms of numbers and/or indices). In addition, the inter-frequency neighboring candidate cells or intra-frequency neighboring cells configured by the network device via SSB-MTC-AddintialPCI-r18 or SSB-MTC-AddintialPCI-r17 include one or more neighboring candidate cells, a data type thereof being a sequence (a length of which is dependent on the number of the configured intra-frequency or inter-frequency neighboring candidate cells). The network device configures the first relevant information and/or the second relevant information respectively for each neighboring candidate cell. In addition, frequency points for the SSBs refer to center frequency points.

For example, when the reference signals are CSI-RSs (including CSI-RSs for beam measurement, CSI-RSs for interference management (CSI-IM) and CSI-RSs for time-frequency tracking (TRS):

In some embodiments, the first relevant information and the second relevant information are carried by an identical information element or information field, that is, the relevant information of the intra-frequency neighboring candidate cells for layer 1 measurement and the relevant information of the inter-frequency neighboring candidate cells for layer 1 measurement are mixed together and configured. For example, neighboring candidate cell configuration information based on CSI-RSs CSI-RS-MTC-AdditionalPCI-r18 may be newly added to carry the first relevant information and/or the second relevant information, wherein CSI-RS-MTC-AdditionalPCI-r18 may be expressed as following by using an ASN. I syntax:

| CSI-RS-MTC-AdditionalPCI-r18 ::= | SEQUENCE { | |
|---|---|---|
| additionalPCIIndex-r18 | AdditionalPCIIndex-r18, | |
| additionalPCI-r18 | PhysCellId, | |
| refFreqCSI-RS | ARFCN-ValueNR | OPTIONAL |
| CSI-RS-subcarrierSpacing | SubcarrierSpacing | OPTIONAL |

...
}

That is, cell identifier information, including an index additionalPCIIndex-r18 of a cell ID and cell ID additionalPCI-r18, may be added to the newly-added CSI-RS-MTC-AdditionalPCI-r18, and CSI-RSs corresponding to additionalPCIIndex-r18 may be found in the indices of the cell identifiers associated with the reference signals in the reference signal measurement resource configuration information. Hence, with this cell identifier information, the CSI-RSs and the cell IDs of the (inter-frequency or intra-frequency) neighboring candidate cells may be associated, wherein data types of the indices additionalPCIIndex-r18 of the cell IDs are integers, and value ranges thereof are dependent on the number of (inter-frequency or intra-frequency) neighboring candidate cells needing to be configured. A data type (PhysCellId) of additionalPCI-r18 is an integer, and a value range thereof is 0 to 1007. Furthermore, for the inter-frequency neighboring candidate cells, an information field refFreqCSI-RS of CSI-RS frequency points of the inter-frequency neighboring candidate cells and/or an information field CSI-RS-subcarrierSpacing of CSI-RS subcarrier spacings of the inter-frequency neighboring candidate cells may be added to CSI-RS-MTC-AdditionalPCI-r18. Furthermore, CSI-RS measurement periodicity configuration information, CSI-RS time-domain resource information and CSI-RS power configuration information may be included, wherein value ranges and data types of the cell identifier information, refFreqCSI-RS and CSI-RS-subcarrierSpacing are identical to those of the frequency points and subcarrier spacings of the SSBs, which shall not be repeated herein any further.

The newly-added information fields refFreqCSI-RS and CSI-RS-subcarrierSpacing are optional, and when they are present in CSI-RS-MTC-AdditionalPCI-r18, it indicates that CSI-RS-MTC-AdditionalPCI-r18 carries the first relevant information; otherwise, when they are not present in CSI-RS-MTC-AdditionalPCI-r18, it indicates that CSI-RS-MTC-AdditionalPCI-r18 carries the second relevant information, that is, when they are present in CSI-RS-MTC-AdditionalPCI-r18, it indicates that a cell to which the cell identifier information carried by CSI-RS-MTC-AdditionalPCI-r18 corresponds is an inter-frequency neighboring candidate cell;

otherwise, when they are not present in CSI-RS-MTC-AdditionalPCI-r18, it indicates that a cell to which the cell identifier information carried by CSI-RS-MTC-AdditionalPCI-r18 corresponds is an intra-frequency neighboring candidate cell. In this example, the cell ID information of the first relevant information and the cell ID information of the second relevant information are indicated by using an identical information element or information field additionalPCIIndex-r18 and additionalPCI-r18.

In some embodiments, the first relevant information and the second relevant information are carried by different information elements or information fields, that is, relevant information of intra-frequency neighboring candidate cell and inter-frequency neighboring candidate cell for layer 1 measurement is separately configured. For example, for the intra-frequency neighboring candidate cells, the newly-added CSI-RS-MTC-AdditionalPCI-r18 may be used to configure the second relevant information, wherein CSI-RS-MTC-AdditionalPCI-r18 may be expressed as follows by using an ASN. I syntax:

| | |
|---|---|
| CSI-RS-MTC-AdditionalPCI-r18 ::= | SEQUENCE { |
| additionalPCIIndex-r18 | AdditionalPCIIndex-r18, |
| additionalPCI-r18 | PhysCellId, |

...
}

That is, the cell identifier information, namely, (intra-frequency) information field additionalPCIIndex-r18 and information field additionalPCI-r18, is added. Furthermore, CSI-RS measurement periodicity configuration information, CSI-RS time-domain resource information and CSI-RS power configuration information may be included. The above information is taken as the second relevant information, and CSI-RSs corresponding to additionalPCIIndex-r18 may be found in the indices of the cell identifiers associated with the reference signals in the reference signal measurement resource configuration information. Hence, with this cell identifier information, the CSI-RSs and the cell IDs of the (intra-frequency) neighboring candidate cells may be associated. In addition, value ranges and data types of the information fields are similar to those described in the previous embodiments, which shall not be repeated herein any further.

For the inter-frequency neighboring candidate cells, the first relevant information may be configured by using the newly-added information element CSI-RS-MTC-AdditionalPCI-r18′, wherein CSI-RS-MTC-AdditionalPCI-r18′ may be expressed as follows by using an ASN. I syntax:

| | |
|---|---|
| CSI-RS-MTC-AdditionalPCI-r18′ | SEQUENCE { |

::=

| additionalPCIIndex-r18 ‘ | AdditionalPCIIndex-r18, | |
|---|---|---|
| additionalPCI-r18 ‘ | PhysCellId, | |
| refFreqCSI-RS | ARFCN-ValueNR | OPTIONAL |
| CSI-RS-subcarrierSpacing | SubcarrierSpacing | OPTIONAL |

...
}

That is, the cell identifier information, namely, (inter-frequency) information field additionalPCIIndex-r18′ and information field additionalPCI-r18′, is added to the newly-added CSI-RS-MTC-AdditionalPCI-r18′. Furthermore, an information field refFreqCSI-RS of CSI-RS frequency points of inter-frequency neighboring candidate cells and/or an information field CSI-RS-subcarrierSpacing of CSI-RS subcarrier spacings of inter-frequency neighboring candidate cells may also be added to CSI-RS-MTC-AdditionalPCI-r18′, and specific implementations thereof are as described above, which shall not be repeated herein any further. CSI-RS measurement periodicity configuration information periodicity-r18, CSI-RS time-domain resource information and CSI-RS power configuration information may further be included. The above information is taken as the first relevant information, and CSI-RSs corresponding to additionalPCIIndex-r18′ may be found in the indices of the cell identifiers associated with the reference signals in the reference signal measurement resource configuration information. Hence, with this cell identifier information, the CSI-RSs and the cell IDs of the (inter-frequency) neighboring candidate cells may be associated. In addition, value ranges and data types of the information fields are similar to those described in the previous embodiments, which shall not be repeated herein any further.

In associating the CSI-RSs above, the intra-frequency neighboring candidate cells and the inter-frequency neighboring candidate cells may respectively be associated with a group of CSI-RSs, that is, CSI-RSs with which additionalPCIIndex-r18 is associated and CSI-RSs with which additionalPCIIndex-r18′ is associated are different (in terms of numbers and/or indices). In addition, the inter-frequency neighboring candidate cells or intra-frequency neighboring cells configured by the network device via CSI-RS-MTC-AdditionalPCI-r18 or CSI-RS-MTC-AdditionalPCI-r18′ include one or more neighboring candidate cells, a data type thereof being a sequence. The network device configures the first relevant information and/or the second relevant information respectively for each neighboring candidate cell. In addition, frequency points for the CSI-RSs refer to a frequency point of point A.

In some embodiments, the network device of the serving cell may further transmit report configuration information (configured by RRC signaling), which is used to configure parameters needed by the terminal equipment in measurement and report. For example, the report configuration information includes a report quantity, and a report configuration type, etc. For example, the report quantity includes L1-RSRP (reference signal receiving power) or L1-SNR (signal to noise ratio), and reference may be made to the related art, and the embodiments of this disclosure are not limited thereto.

In some embodiments, after the reference signal measurement resource configuration information and the report configuration information are configured, the network device of the serving cell and the network device of the neighboring candidate cells may transmit respective reference signals to be measured to the terminal equipment and the network device configures such information as time-frequency resources, and periodicity, etc., in the reference signal measurement resource configuration information, and transmit corresponding reference signals on corresponding time-frequency resources, so that the terminal equipment performs layer 1 measurement on the received reference signals. In 202, the measurement report is carried by UCI. The terminal equipment measures signal quality of the serving cell and/or the neighboring candidate cells (including intra-frequency neighboring candidate cells or inter-frequency neighboring candidate cells) according to the received reference signals and the first relevant information and/or the second relevant information. The measurement result may be L1-RSRP or a L1-SNR, and this disclosure is not limited thereto. The measurement result may include a measurement result of the serving cell, measurement results of the intra-frequency neighboring candidate cells (if configuration information of the intra-frequency neighboring cells is configured, or if the second relevant information is received), and measurement results of the inter-frequency neighboring candidate cells (if configuration information of the inter-frequency neighboring cells is configured, or if the first relevant information is received). The measurement results may be measurement results based on the reference signals (SSBs), and may also be measurement results based on CSI-RSs. The measurement report may include measurement result(s) of one or more neighboring candidate cells, and the measurement results of the inter-frequency neighboring candidate cells may include a measurement result of one frequency point, or may include measurement results of multiple frequency points. Each frequency point may have one measurement result, or may have multiple measurement results. Which measurement results are included in the measurement report is carried out by an algorithm of the terminal equipment, and this disclosure is not limited thereto.

In some embodiments, after receiving the measurement report, the network device of the serving cell may select a target cell for switch according to an algorithm, and transmit a switch command to the terminal equipment via layer 1 or layer 2 signaling.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

With the above embodiment, by configuring the terminal equipment with the first relevant information of an inter-frequency neighboring candidate cell for layer 1 measurement based on a reference signal, layer 1/layer 2 triggered mobility of inter-frequency neighboring candidate cells may be supported, thereby triggering via the layer 1 measurement results, and performing switch of serving cells via layer 1/layer 2 signaling, which may effectively reduce latency of the system, signaling load and communication interruption time.

### Embodiments of a Second Aspect

The embodiments of this disclosure provide an information transceiving method, which shall be described from a terminal equipment side, with contents identical to those in the embodiments of the first aspect being not going to be described herein any further.

FIG. 3 is a schematic diagram of the information transceiving method of the embodiments of this disclosure. As shown in FIG. 3, the method includes:
301: the terminal equipment receives first relevant information of an inter-frequency neighboring candidate cell for layer 1 measurement based on a reference signal transmitted by a network device; and
302: the terminal equipment transmits a measurement report for one or more cell(s) included in the candidate cell(s) to the network device.

It should be noted that FIG. 3 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 3.

In some embodiments, implementations of 301-302 correspond to those of 202-202, and reference may be made to the embodiments of the first aspect for implementations of the information, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

With the above embodiment, by configuring the terminal equipment with the first relevant information of an inter-frequency neighboring candidate cell for layer 1 measurement based on a reference signal, layer 1/layer 2 triggered mobility of inter-frequency neighboring candidate cells may be supported, thereby triggering via the layer 1 measurement results, and performing switch of serving cells via layer 1/layer 2 signaling, which may effectively reduce latency of the system, signaling load and communication interruption time.

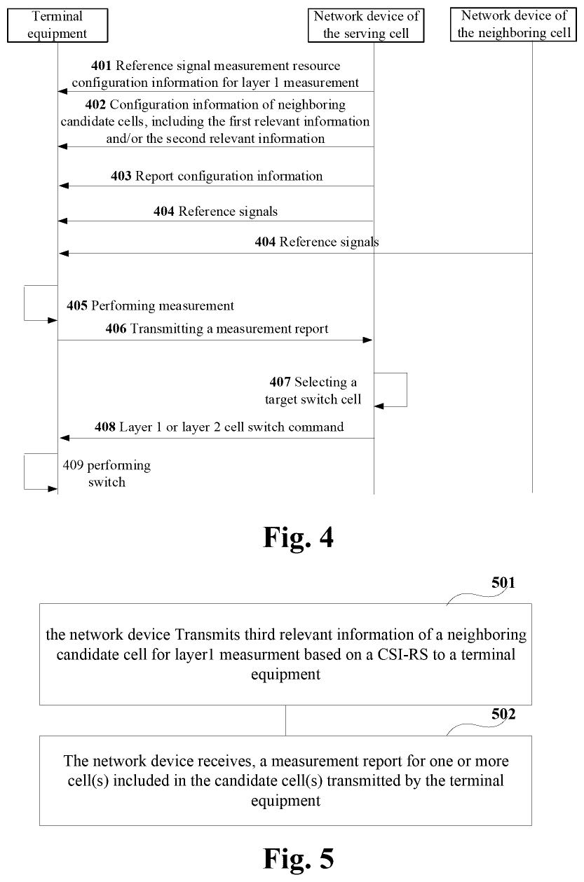

The cell switch method of the embodiments of this disclosure is described above for the embodiments of the first and second aspects. FIG. 4 is a schematic diagram of the layer 1/lay 2 triggered cell switch method of the embodiments of this disclosure. As shown in FIG. 4, the method includes:
401: the network device of the serving cell transmits reference signal measurement resource configuration information for layer 1 measurement to the terminal equipment, including, for example, indices of cell identifiers associated with reference signals;
402: the network device of the serving cell transmits configuration information of neighboring candidate cells to the terminal equipment, including, for example, the above first relevant information and/or the second relevant information;
403: the network device of the serving cell transmits report configuration information to the terminal equipment;
404: the network device of the serving cell and/or a network device of configured neighboring candidate cells transmits associated reference signals;
405: the terminal equipment measures the received reference signals (L1-SNR or L1-RSRP);
406: the terminal equipment transmits a measurement report for one or more cell(s) included in the candidate cell(s) to the network device of the serving cell;
407: the network device of the serving cell selects a target switch cell according to the measurement report;
408: the network device of the serving cell transmits a layer 1 or layer 2 cell switch command to the terminal equipment; and
409: the terminal equipment switches to the target cell according to the switch command.

Implementations of 401-409 are as described above, which shall not be repeated herein any further.

### Embodiments of a Third Aspect

The embodiments of this disclosure provide an information transceiving method, which shall be described from a network device side, with contents identical to those in the embodiments of the first aspect being not going to be described herein any further.

FIG. 5 is a schematic diagram of the information transceiving method of the embodiments of this disclosure. As shown in FIG. 5, the method includes:
501: the network device transmits third relevant information of a neighboring candidate cell for layer 1 measurement based on a CSI-RS to a terminal equipment; and
502: the network device receives, a measurement report for one or more cell(s) included in the candidate cell(s) transmitted by the terminal equipment.

It should be noted that FIG. 5 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 5.

In some embodiments, the CSI-RS is used for measurement of layer 1/layer 2 triggered mobility, and the network device of a serving cell may configure reference signal resources for a current serving cell measurement and neighboring cell measurement. That is, the method may include: the network device transmits CSI-RS measurement resource configuration information for layer 1 measurement to the terminal equipment, wherein the CSI-RS measurement resource configuration information may be carried by RRC signaling. A measurement resource and a reference signal are interchangeable below. Reference may be made to example 2 or example 3 or example 4 of the embodiments of the first aspect for implementation of the CSI-RS measurement resource configuration information for layer 1 measurement, and the embodiments of this disclosure are not limited thereto.

In some embodiments, the network device of the serving cell may transmit configuration information for neighboring candidate cells to the terminal equipment, wherein the neighboring candidate cells may be intra-frequency neighboring candidate cells or inter-frequency neighboring candidate cells, that is, the configuration information at least includes the third relevant information (carried by RRC signaling) of a neighboring candidate cell for layer 1 measurement based on a CSI-RS.

In some embodiments, the third relevant information of a neighboring candidate cell for layer 1 measurement based on a CSI-RS includes cell identifier information, that is, for intra-frequency neighboring candidate cells or inter-frequency neighboring candidate cells, the third relevant information includes cell identifier information, and the neighboring candidate cells include one or more neighboring cells. Reference may be made to the embodiments of the first aspect for implementation of the cell identifier information. With indices of cell identifiers in the cell identifier information, CSI-RSs corresponding to indices of cell identifiers in the cell identifier information may be found in the indices of the cell identifiers associated with CSI-RSs in the reference signal measurement resource configuration information. Therefore, with the cell identifier information, the CSI-RSs and the cell ID of the (intra-frequency or inter-frequency) neighboring candidate cells may be associated.

For example, configuration information CSI-RS-MTC-AdditionalPCI-r18 or CSI-RS-MTC-AdditionalPCI-r18′ for neighboring candidate cells based on CSI-RSs may be newly added to carry the third relevant information, wherein reference may be made to the embodiments of the first aspect for implementations of CSI-RS-MTC-AdditionalPCI-r18 or CSI-RS-MTC-AdditionalPCI-r18′, which shall not be repeated herein any further.

For example, for the inter-frequency neighboring candidate cells, the third relevant information may further include CSI-RS frequency points and/or CSI-RS subcarrier spacings. For example, an information field refFreqCSI-RS of the CSI-RS frequency points of the inter-frequency neighboring candidate cells and/or an information field CSI-RS-subcarrierSpacing of the CSI-RS subcarrier spacings of the inter-frequency neighboring candidate cells may be newly added, wherein specific implementations of the information fields (whether they are included, value ranges, and data types, etc.) are as described above, which shall not be repeated herein any further. And at least one of CSI-RS measurement periodicity configuration information, CSI-RS power configuration information, and CSI-RS time-frequency resource information may further be included.

In some embodiments, the configuration information based on CSI-RSs for an intra-frequency neighboring candidate cell and the configuration information based on CSI-RSs for an inter-frequency neighboring candidate cell may be carried by an identical information element or information field, or may be carried by different information elements or information fields, and reference may be made to the embodiments of the first aspect for details, which shall not be repeated herein any further.

In some embodiments, reference may be made to 202 for implementation of 502, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

With the above embodiment, by configuring the terminal equipment with third relevant information of neighboring candidate cell for layer 1 measurement based on CSI-RSs, layer 1/layer 2 triggered mobility of neighboring candidate cells based on CSI-RSs may be supported, thereby triggering via the layer 1 measurement results, and performing switch of serving cells via layer 1/layer 2 signaling, which may support synchronization with higher precision and higher received signal to noise ratio after the switch, thereby further reducing latency of the system, signaling load and communication interruption time.

### Embodiments of a Fourth Aspect

The embodiments of this disclosure provide an information transceiving method, which shall be described from a terminal equipment side, with contents identical to those in the embodiments of the third aspect being not going to be described herein any further.

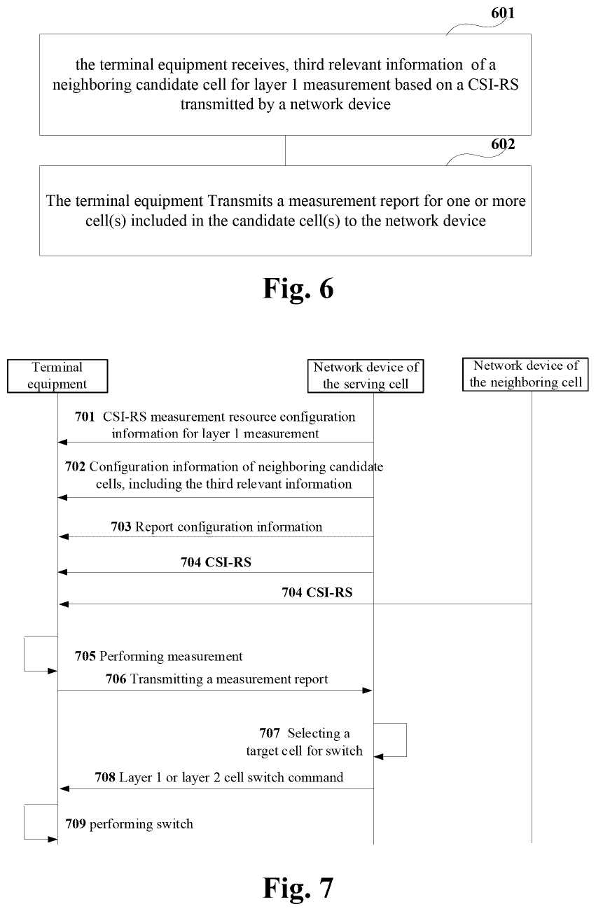

FIG. 6 is a schematic diagram of the information transceiving method of the embodiments of this disclosure. As shown in FIG. 6, the method includes:
601: the terminal equipment receives, third relevant information of a neighboring candidate cell for layer 1 measurement based on a CSI-RS transmitted by a network device; and
602: the terminal equipment transmits a measurement report for one or more cell(s) included in the candidate cell(s) to the network device.

It should be noted that FIG. 6 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 3.

In some embodiments, implementations of 601-602 correspond to those of 502-502, and reference may be made to the embodiments of the third aspect for implementations of the information, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

With the above embodiment, by configuring the terminal equipment with third relevant information of neighboring candidate cell for layer 1 measurement based on CSI-RSs, layer 1/layer 2 triggered mobility of neighboring candidate cells based on CSI-RSs may be supported, thereby triggering via the layer 1 measurement results, and performing switch of serving cells via layer 1/layer 2 signaling, which may support synchronization with higher precision and higher received signal to noise ratio after the switch, thereby further reducing latency of the system, signaling load and communication interruption time.

The cell switch method of the embodiments of this disclosure are described above for the embodiments of the third and fourth aspects. FIG. 7 is a schematic diagram of the layer 1/lay 2 triggered cell switch method of the embodiments of this disclosure. As shown in FIG. 7, the method includes:
701: a network device of a serving cell transmits CSI-RS measurement resource configuration information for layer 1 measurement to the terminal equipment, including, for example, indices of cell identifiers associated with CSI-RSs;
702: the network device of the serving cell transmits configuration information of neighboring candidate cells to the terminal equipment, including, for example, the above third relevant information;
703: the network device of the serving cell transmits report configuration information to the terminal equipment;
704: the network device of the serving cell and/or a network device of configured neighboring candidate cells transmit(s) associated CSI-RSs;
705: the terminal equipment measures the received CSI-RS (L1-SNR or L1-RSRP);
706: the terminal equipment transmits a measurement report for one or more cell(s) included in the candidate cell(s) to the network device of the serving cell;
707: the network device of the serving cell selects a target cell for switch according to the measurement report;
708: the network device of the serving cell transmits a layer 1 or layer 2 cell switch command to the terminal equipment; and
709: the terminal equipment switches to the target cell according to the switch command.

Implementations of 701-709 are as described above, which shall not be repeated herein any further.

As described in the embodiments of the first to fourth aspects, when the reference signals are CSI-RSs, in the CSI-RS measurement resource configuration information for layer 1 measurement, the cell identifiers of neighboring candidate cells are explicitly indicated, and for inter-frequency neighboring candidate cells, the frequency points of the CSI-RSs of the inter-frequency neighboring candidate cells and/or the subcarrier spacings of the CSI-RSs of the inter-frequency neighboring cells need further to be explicitly indicated. A difference from the embodiments of the first to fourth aspects exists in that the CSI-RS measurement resource configuration for layer 1 measurement may also be implicitly configured, which shall be described below with reference to embodiments of a fifth and sixth aspects.

### Embodiments of a Fifth Aspect

The embodiments of this disclosure provide an information configuration method, which shall be described from a network device side.

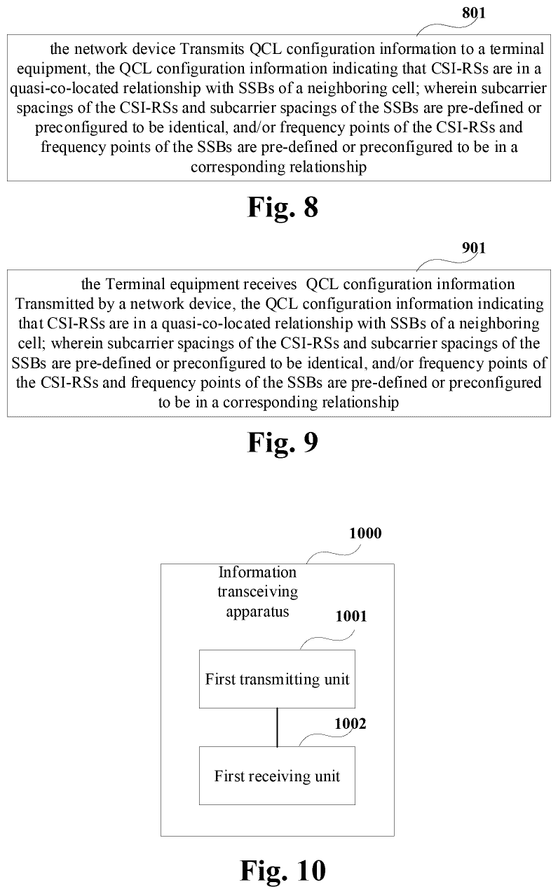

FIG. 8 is a schematic diagram of the information configuration method of the embodiments of this disclosure. As shown in FIG. 8, the method includes:
801: the network device transmits QCL configuration information to a terminal equipment, the QCL configuration information indicating that CSI-RSs are in a quasi-co-located relationship with SSBs of a neighboring cell;
wherein subcarrier spacings of the CSI-RSs and subcarrier spacings of the SSBs are pre-defined or preconfigured to be identical, and/or frequency points of the CSI-RSs and frequency points of the SSBs are pre-defined or preconfigured to be in a corresponding relationship.

In some embodiments, in order to support implicitly performing CSI-RS measurement resource configuration for layer 1 measurement, it is needed to predefine or preconfigure that the subcarrier spacings of the CSI-RSs are identical to those of the SSBs, and/or predefine or preconfigure that the frequency points of the CSI-RSs and the frequency points of the SSBs have a corresponding relationship, or, in other words, the frequency points of the CSI-RSs may be derived from configured frequency points of the SSBs. According to the predefining or preconfiguring, the frequency points and subcarrier spacings of the CSI-RSs may be determined based on the configured frequency points of the SSBs and subcarrier spacings of the SSBs.

In some embodiments, by configuring the QCL configuration information, it is indicated that the CSI-RSs and the SSBs of the neighboring cell are in a quasi-co-located relationship, thus, reception of the CSI-RS signals is performed with reference to the SSBs of the neighboring cell, i.e. reception of the CSI-RSs QCL to the SSBs of the neighboring cell, thereby indirectly associating the CSI-RSs with the neighboring cell. The QCL configuration information may be carried by CSI-RS measurement resource configuration information NZP-CSI-RS-Resource.

For example, the CSI-RS measurement resource configuration information may be expressed as follows by using an ASN.1 data format:

| | |
|---|---|
| NZP-CSI-RS-Resource ::= | SEQUENCE { |
| nzp-CSI-RS-ResourceId | NZP-CSI-RS-ResourceId, |
| resourceMapping | CSI-RS-ResourceMapping, |
| powerControlOffset | INTEGER (−8..15), |
| powerControlOffsetSS | ENUMERATED{db−3, db0, db3, db6} |

OPTIONAL, -- Need R

| | |
|---|---|
| scramblingID | ScramblingId, |
| periodicityAndOffset | CSI-ResourcePeriodicityAndOffset |

OPTIONAL, -- Cond PeriodicOrSemiPersistent

| | |
|---|---|
| qcl-InfoPeriodicCSI-RS | TCI-StateId |

OPTIONAL, -- Cond Periodic
...
}

| | |
|---|---|
| TCI-State ::= | SEQUENCE { |
| tci-StateId | TCI-StateId, |
| qcl-Type1 | QCL-Info, |
| qcl-Type2 | QCL-Info |

```
OPTIONAL, -- Need R
  ...,
  [[
```

| | |
|---|---|
| additionalPCI-r17 | AdditionalPCIIndex-r17 |
| OPTIONAL, -- Need R | |
| pathlossReferenceRS-Id-r17 | PUSCH-PathlossReferenceRS-Id-r17 |

OPTIONAL, -- Cond JointTCI

| | |
|---|---|
| ul-powerControl-r17 | Uplink-powerControlId-r17 |

OPTIONAL -- Cond JointTCI
]]
}

| | |
|---|---|
| QCL-Info ::= | SEQUENCE { |
| cell | ServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, |

typeD},
...
}

As shown above, in the measurement resource configuration information, an information field qcl-InfoPeriodicCSI-RS is included, which denotes the QCL configuration information of the measurement resource. The QCL configuration information includes a transmission configuration indication state identifier TCI-stateID, an ID (additional PCI-r17) of a neighboring cell associated with the transmission configuration indication state identifier may be obtained from a configured transmission configuration indication state (TCI-State) list, an SSB index of the neighboring cell may be obtained via an information field qcl-type1/2, and the terminal equipment associates the CSI-RSs with the neighboring cell according to the QCL configuration information in the CSI-RS measurement resource configuration information, instead of by explicitly associating by adding the indices of the cell identifiers described in the previous embodiments. That is, if the configured source reference signals SSBs of the CSI-RSs come from the neighboring cell (associated with the neighboring cell), it is indirectly indicated that the CSI-RSs also come from the neighboring cell (associated with the neighboring cell), and the measurement performed on the CSI-RSs is measurement of signal quality of the neighboring cell (not measurement of the current serving cell). As described above, in order to support indirectly indicating, the subcarrier spacings of the CSI-RSs and the subcarrier spacings of the SSBs of the neighboring cell are predefined or preconfigured to be identical, and/or the frequency points of the CSI-RSs and the frequency points of the SSBs of the neighboring cell are predefined or preconfigured to be in a corresponding relationship.

### Embodiments of a Sixth Aspect

The embodiments of this disclosure provide an information configuration method, which shall be described from a terminal equipment side.

FIG. 9 is a schematic diagram of the information configuration method of the embodiments of this disclosure. As shown in FIG. 9, the method includes:
901: a terminal equipment receives, QCL configuration information transmitted by a network device, the QCL configuration information indicating that CSI-RSs are in a quasi-co-located relationship with SSBs of a neighboring cell;
wherein the terminal equipment expects that subcarrier spacings of the CSI-RSs and subcarrier spacings of the SSBs are predefined or preconfigured to be identical, and/or, frequency points of the CSI-RSs and frequency points of the SSBs are predefined or preconfigured to be in a corresponding relationship.

Reference may be made to the embodiments of the fifth aspect for implementation of 901, and the method may further include (not shown): the terminal equipment receives CSI-RS signals, wherein the terminal equipment receives the CSI-RS signals with reference to SSBs of the neighboring cell, and reference may be made to the related art for details, which shall not be repeated herein any further.

### Embodiments of a Seventh Aspect

The embodiments of this disclosure provide an information transceiving apparatus. The apparatus may be, for example, a network device, or one or some components or assemblies configured in the network device. Contents in the embodiments identical to those in the embodiments of the first or the third aspect shall not be described herein any further.

FIG. 10 is a schematic diagram of the information transceiving apparatus of the embodiments of this disclosure. As shown in FIG. 10, the information transceiving apparatus 1000 includes a first transmitting unit 1001 and a first receiving unit 1002.

In some embodiments, the first transmitting unit 1001 is configured to transmit first relevant information of an inter-frequency neighboring candidate cell for layer 1 measurement based on a reference signal to a terminal equipment, and the first receiving unit 1002 is configured to receive a measurement report for one or more cell(s) included in the candidate cell(s) transmitted by the terminal equipment.

In some embodiments, the first transmitting unit 1001 is further configured to transmit reference signal measurement resource configuration information for the layer 1 measurement to the terminal equipment, the reference signal measurement resource configuration information including a reference signal set identifier, indices of reference signals in the reference signal set, and indices of cell identifiers associated with the reference signals.

In some embodiments, the first transmitting unit 1001 is further configured to transmit second relevant information of intra-frequency neighboring candidate cell for layer 1 measurement based on a reference signal to the terminal equipment.

Reference may be made to the embodiments of the first aspect for implementations of the information and units, which shall not be repeated herein any further.

In some embodiments, the first transmitting unit 1001 is further configured to transmit third relevant information of a neighboring candidate cell for layer 1 measurement based on a CSI-RS to the terminal equipment, and the first receiving unit 1002 is further configured to receiving a measurement report for one or more cell(s) included the candidate cell(s) transmitted by the terminal equipment.

In some embodiments, the first transmitting unit 1001 is further configured to transmit CSI-RS measurement resource configuration information for layer 1 measurement to the terminal equipment, including a CSI-RS resource set identifier, identifiers of CSI-RS resources in the CSI-RS resource set, and indices of cell identifiers with which the CSI-RS resources are associated.

Reference may be made to the embodiments of the third aspect for implementations of the information and units, which shall not be repeated herein any further.

In some embodiments, the information transceiving apparatus 1000 may be taken as an information configuration apparatus 1000, and the first transmitting unit 1001 may be configured to transmit QCL configuration information to the terminal equipment, the QCL configuration information indicating that CSI-RSs are in a quasi-co-located relationship with SSBs of a neighboring cell; wherein subcarrier spacings of the CSI-RSs and subcarrier spacings of the SSBs are pre-defined or preconfigured to be identical, and/or frequency points of the CSI-RSs and frequency points of the SSBs are pre-defined or preconfigured to be in a corresponding relationship, and reference may be made to the embodiments of the fifth aspect for implementations thereof, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 1000 may further include other components or modules, and reference may be made to related techniques for particulars of these components or modules.

Furthermore, for the sake of simplicity, connection relationships between the components or modules or signal profiles thereof are only illustrated in FIG. 10. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

### Embodiments of an Eighth Aspect

The embodiments of this disclosure provide an information transceiving apparatus. The apparatus may be, for example, a terminal equipment, or one or some components or assemblies configured in the terminal equipment. Contents in the embodiments identical to those in the embodiments of the second or the fourth aspect shall not be described herein any further.

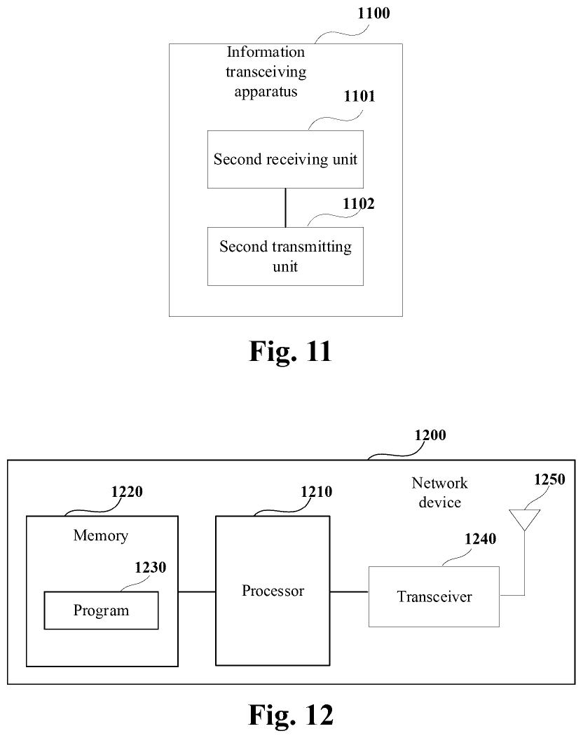

FIG. 11 is a schematic diagram of the information transceiving apparatus of the embodiments of this disclosure. As shown in FIG. 11, the information transceiving apparatus 1100 includes a second receiving unit 1101 and a second transmitting unit 1102.

In some embodiments, the second receiving unit 1101 is configured to receive first relevant information of an inter-frequency neighboring candidate cell for layer 1 measurement based on a reference signal transmitted by a network device, or receive second relevant information of intra-frequency neighboring candidate cell for layer 1 measurement based on reference signals transmitted by the network device, or receive third relevant information of neighboring candidate cell for layer 1 measurement based on CSI-RSs transmitted by the network device, and the second transmitting unit 1102 is configured to transmit a measurement report for one or more cell(s) included the candidate cell(s) to the network device.

Reference may be made to the embodiments of the second or fourth aspect for implementations of the information and units, which shall not be repeated herein any further.

In some embodiments, the information transceiving apparatus 1100 may be taken as an information configuration apparatus 1100, and the second receiving unit 1101 may be configured to receive QCL configuration information transmitted by the network device, the QCL configuration information indicating that CSI-RSs are in a quasi-co-located relationship with SSBs of a neighboring cell; wherein the terminal equipment expects that subcarrier spacings of the CSI-RSs and subcarrier spacings of the SSBs are predefined or preconfigured to be identical, and/or, frequency points of the CSI-RSs and frequency points of the SSBs are predefined or preconfigured to be in a corresponding relationship, and reference may be made to the embodiments of the fifth aspect for implementations thereof, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 1100 may further include other components or modules, and reference may be made to related techniques for particulars of these components or modules.

Furthermore, for the sake of simplicity, connection relationships between the components or modules or signal profiles thereof are only illustrated in FIG. 11. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

### Embodiments of a Ninth Aspect

The embodiments of this disclosure provide a communication system, and reference may be made to FIG. 1, with contents identical to those in the embodiments of the first to the eighth aspects being not going to be described herein any further.

In some embodiments, the communication system 100 may at least include a network device 101 and/or a terminal equipment 102, wherein the network device 101 includes the information transceiving (configuration) apparatus 1000 described in the embodiments of the seventh aspect, and the terminal equipment 102 includes the information transceiving (configuration) apparatus 1100 described in the embodiments of the eighth aspect, which shall not be described herein any further.

The embodiments of this disclosure further provide a network device, which may be, for example, a base station. However, this disclosure is not limited thereto, and it may also be another network device.

FIG. 12 is a schematic diagram of a structure of the network device of the embodiments of this disclosure. As shown in FIG. 12, the network device 1200 may include a processor 1210 (such as a central processing unit (CPU)) and a memory 1220, the memory 1220 being coupled to the processor 1210. Wherein, the memory 1220 may store various data, and furthermore, it may store a program 1230 for information processing, and execute the program 1230 under control of the processor 1210.

For example, the processor 1210 may be configured to execute a program to carry out the information transceiving method described in the embodiments of the first or the third aspect, or the information configuration method described in the embodiments of the fifth aspect.

Furthermore, as shown in FIG. 12, the network device 1200 may include a transceiver 1240, and an antenna 1250, etc. Wherein, functions of the above components are similar to those in the related art, and shall not be described herein any further. It should be noted that the network device 1200 does not necessarily include all the parts shown in FIG. 12, and furthermore, the network device 1200 may include parts not shown in FIG. 12, and the related art may be referred to.

The embodiments of this disclosure further provide a terminal equipment; however, this disclosure is not limited thereto, and it may also be another equipment.

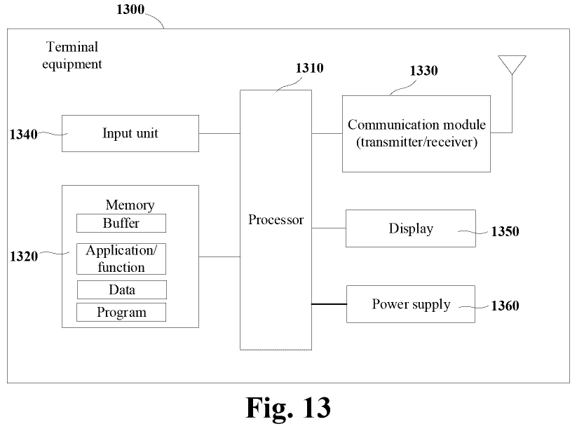

FIG. 13 is a schematic diagram of the terminal equipment of the embodiments of this disclosure. As shown in FIG. 13, the terminal equipment 1300 may include a processor 1310 and a memory 1320, the memory 1320 storing data and a program and being coupled to the processor 1310. It should be noted that this figure is illustrative only, and other types of structures may also be used, so as to supplement or replace this structure and achieve a telecommunications function or other functions.

For example, the processor 1310 may be configured to execute a program to carry out the information transceiving method as described in the embodiments of the second or the fourth aspect, or the information configuration method as described in the embodiments of the sixth aspect.

As shown in FIG. 13, the terminal equipment 1300 may further include a communication module 1330, an input unit 1340, a display 1350, and a power supply 1360; wherein functions of the above components are similar to those in the related art, which shall not be described herein any further. It should be noted that the terminal equipment 1300 does not necessarily include all the parts shown in FIG. 13, and the above components are not necessary. Furthermore, the terminal equipment 1300 may include parts not shown in FIG. 13, and the related art may be referred to.

Embodiments of this disclosure provide a computer program, which, when executed in a terminal equipment, will cause the terminal equipment to carry out the information transceiving method as described in the embodiments of the second or the fourth aspect, or the information configuration method as described in the embodiments of the sixth aspect.

Embodiments of this disclosure provide a computer storage medium, including a computer program, which will cause a terminal equipment to carry out the information transceiving method as described in the embodiments of the second or the fourth aspect, or the information configuration method as described in the embodiments of the sixth aspect.

Embodiments of this disclosure provide a computer program, which, when executed in a network device, will cause the network device to carry out the information transceiving method as described in the embodiments of the first or the third aspect, or the information configuration method as described in the embodiments of the fifth aspect.

Embodiments of this disclosure provide a computer storage medium, including a computer program, which will cause a network device to carry out the information transceiving method as described in the embodiments of the first or the third aspect, or the information configuration method as described in the embodiments of the fifth aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.
1. An information transceiving method, applicable to a network device, characterized in that the method includes:
a first transmitting unit configured to transmit first relevant information of an inter-frequency neighboring candidate cell for layer 1 measurement based on a reference signal to a terminal equipment; and
a first receiving unit configured to receive a measurement report for one or more cell(s) included the candidate cell(s) transmitted by the terminal equipment.
2. The method according to supplement 1, wherein the inter-frequency neighboring candidate cells include one or more neighboring cells, and at least one of center frequency points and subcarrier spacings of the inter-frequency neighboring candidate cells and the serving cell are different.
3. The method according to supplement 1, wherein the first relevant information includes cell identifier information and at least one of a reference signal frequency point and a reference signal subcarrier spacing.
4. The method according to supplement 1, wherein the first transmitting unit is further configured to transmit reference signal measurement resource configuration information for the layer 1 measurement to the terminal equipment, the reference signal measurement resource configuration information including a reference signal set identifier, indices of reference signals in the reference signal set, and indices of cell identifiers associated with the reference signals.
5. The method according to supplement 1, wherein the first transmitting unit is further configured to transmit second relevant information of intra-frequency neighboring candidate cell for layer 1 measurement based on a reference signal to the terminal equipment.
6. The method according to supplement 3 or 5, wherein the second relevant information includes cell identifier information.
7. The method according to supplement 5, wherein the first relevant information and the second relevant information are carried by an identical information element or information field, or by different information elements or information fields.
8. The method according to supplement 6, wherein the cell identifier information of the first relevant information and the cell identifier information of the second relevant information are indicated by an identical information element or information field, or by different information elements or information fields.
9. The method according to supplement 3 or 6, wherein the cell identifier information includes a cell identifier and an index of the cell identifier.
10. The method according to supplement 1 or 5, wherein the first relevant information and/or the second relevant information further include(s) at least one of reference signal measurement periodicity configuration information, reference signal power configuration information, and reference signal time-frequency resource information.
11. The method according to supplement 4, wherein the reference signal measurement resource includes at least one of a CSI-RS resource for beam management, an SSB resource, a CSI-RS resource for interference management (CSI-IM), and a CSI-RS resource for time-frequency tracking (TRS).
12. The method according to supplement 4, wherein the reference signal set is used for measurement of layer 1/layer 2 triggered mobility.
13. The method according to supplement 4, wherein the reference signal measurement resource configuration information further includes indication information indicating that the reference signal set is used for measurement of layer 1/layer 2 triggered mobility.
14. The method according to supplement 13, wherein when the reference signal measurement resource configuration information includes the indication information, the reference signal measurement resource configuration information includes an index of the cell identifier.
15. The method according to supplement 1 or 5, wherein the measurement report includes a measurement result of an intra-frequency cell and/or inter-frequency cell.
16. The method according to supplement 15, wherein the measurement result includes L1-RSRP or an L1-SNR.
17. The method according to supplement 1, wherein the first relevant information is carried by RRC, and the measurement report is carried by UCI.
18. An information transceiving method, applicable to a terminal equipment, characterized in that the method includes:
a second receiving unit configured to receive first relevant information of an inter-frequency neighboring candidate cell for layer 1 measurement based on a reference signal transmitted by a network device; and
a second transmitting unit configured to transmit a measurement report for one or more cell(s) included the candidate cell(s) to the network device.
19. The method according to supplement 18, wherein the first relevant information includes cell identifier information and at least one of a reference signal frequency point and a reference signal subcarrier spacing.
20. An information configuration method, applicable to a network device, characterized in that the method includes:
transmitting QCL configuration information by the network device to a terminal equipment, the QCL configuration information indicating that CSI-RSs are in a quasi-co-located relationship with SSBs of a neighboring cell;
wherein subcarrier spacings of the CSI-RSs and subcarrier spacings of the SSBs are pre-defined or preconfigured to be identical, and/or frequency points of the CSI-RSs and frequency points of the SSBs are pre-defined or preconfigured to be in a corresponding relationship.
21. The method according to supplement 20, wherein the CSI-RSs are used for measurement of layer 1/layer 2 triggered mobility.
22. The method according to supplement 20, wherein the CSI-RSs include at least one of a CSI-RS resource for beam management, a CSI-RS for interference management (CSI-IM), and a CSI-RS for time-frequency tracking (TRS).
23. An information transceiving method, applicable to a network device, characterized in that the method includes:
transmitting third relevant information of a neighboring candidate cell for layer 1 measurement based on a CSI-RS by the network device to a terminal equipment; and
receiving, by the network device, a measurement report for one or more cell(s) included the candidate cell(s) transmitted by the terminal equipment.
24. The method according to supplement 23, wherein the CSI-RSs are used for measurement of layer 1/layer 2 triggered mobility.
25. The method according to supplement 23, wherein the third relevant information includes cell identifier information.
26. The method according to supplement 25, wherein when the cell is an inter-frequency neighboring candidate cell, the third relevant information further includes frequency points of the CSI-RSs and/or subcarrier spacings of the CSI-RSs.
27. The method according to supplement 23, wherein the method further includes:
transmitting CSI-RS measurement resource configuration information for layer 1 measurement by the network device to the terminal equipment, including a CSI-RS resource set identifier, identifiers of CSI-RS resources in the CSI-RS resource set, and indices of cell identifiers associated with the CSI-RS resources.
28. The method according to supplement 25, wherein the cell identifier information includes a cell identifier and an index of the cell identifier.
29. An information configuration method, applicable to a terminal equipment, characterized in that the method includes:
receiving, by a terminal equipment, QCL configuration information transmitted by a network device, the QCL configuration information indicating that CSI-RSs are in a quasi-co-located relationship with SSBs of a neighboring cell;
wherein the terminal equipment expects that subcarrier spacings of the CSI-RSs and subcarrier spacings of the SSBs are predefined or preconfigured to be identical, and/or, frequency points of the CSI-RSs and frequency points of the SSBs are predefined or preconfigured to be in a corresponding relationship.
30. An information transceiving method, applicable to a terminal equipment, characterized in that the method includes:
receiving, by a terminal equipment, third relevant information of a neighboring candidate cell for layer 1 measurement based on a CSI-RS transmitted by a network device; and
transmitting a measurement reported by the terminal equipment for one or more cell(s) included in the candidate cell(s) to the network device.
31. A network device, including a memory and a processor, the memory storing a computer program, and the processor being configured to execute the computer program to carry out the method as described in any one of supplements 1-17 and 20-28.
32. A terminal equipment, including a memory and a processor, the memory storing a computer program, and the processor being configured to execute the computer program to carry out the method as described in any one of supplements 18 or 19 or 29 or 30.

1. An apparatus, applicable to a network device, the apparatus comprising:
a transmitter configured to transmit candidate configuration information for layer 1 or layer 2 (L1/L2) trigger mobility to a terminal equipment, the candidate configuration information at least comprising relevant information of one or more configurations for candidate cell(s); and
a receiver configured to receive a measurement report for one or more cell(s) included in the candidate cell(s) transmitted by the terminal equipment.

2. The apparatus according to claim 1, wherein the configuration for candidate cell(s) at least comprises cell identifier information, a reference signal frequency point and a reference signal subcarrier spacing.

3. The apparatus according to claim 1, wherein the transmitter is further configured to transmit reference signal configuration information for the L1/L2 trigger mobility measurement to the terminal equipment, the reference signal configuration information comprising a reference signal configuration identifier, resource indices of reference signals, and identifiers of configurations for candidate cell(s) associated with the reference signals.

4. The apparatus according to claim 1, wherein an identifier of configuration for candidate cell(s) is associated to an index of reference signal by one to one.

5. The apparatus according to claim 2, wherein the cell identifier information comprises a physical cell identifier.

6. The apparatus according to claim 1, wherein the configuration for candidate cell(s) further comprises reference signal periodicity configuration information, reference signal power configuration information, and reference signal time domain position information.

7. The apparatus according to claim 3, wherein the reference signal at least comprises channel state information reference signal (CSI-RS) for beam management, and/or synchronization signal block (SSB), and/or CSI-RS for interference management (CSI-IM), and/or CSI-RS for time-frequency tracking (TRS).

8. The apparatus according to claim 3, wherein the reference signal is used for measurement of L1/L2 triggered mobility.

9. The apparatus according to claim 1, wherein the measurement report at least comprises layer 1 reference signal received power (L1-RSRP) for the one or more cells.

10. The apparatus according to claim 1, wherein the relevant information is carried by RRC, and the measurement report is carried by UCI.

11. An apparatus, applicable to a terminal equipment, the apparatus comprising:
a receiver configured to receive candidate configuration information for layer 1 or layer 2 (L1/L2) trigger mobility transmitted by a network device, the candidate configuration information at least comprising relevant information of one or more configurations for candidate cell(s); and
a transmitter unit configured to transmit a measurement report for one or more cell(s) included in the candidate cell(s) to the network device.

12. The apparatus according to claim 11, wherein the configuration for candidate cell(s) at least comprises cell identifier information, a reference signal frequency point and a reference signal subcarrier spacing.

13. The apparatus according to claim 11, wherein the transmitter is further configured to transmit reference signal configuration information for the L1/L2 trigger mobility measurement to the terminal equipment, the reference signal configuration information comprising a reference signal configuration identifier, resource indices of reference signals, and identifiers of configurations for candidate cell(s) associated with the reference signals.

14. The apparatus according to claim 11, wherein an identifier of configuration for candidate cell(s) is associated to an index of reference signal by one to one.

15. The apparatus according to claim 12, wherein the cell identifier information comprises a physical cell identifier.

16. The apparatus according to claim 11, wherein the configuration for candidate cell(s) further comprises reference signal period configuration information, reference signal power configuration information, and reference signal time domain position information.

17. The apparatus according to claim 13, wherein the reference signal at least comprises channel state information reference signal (CSI-RS) for beam management, and/or synchronization signal block (SSB), and/or CSI-RS for interference management (CSI-IM), and/or CSI-RS for time-frequency tracking (TRS).

18. The apparatus according to claim 13, wherein the reference signal is used for measurement of L1/L2 triggered mobility.

19. The apparatus according to claim 11, wherein the measurement report at least comprises layer 1 reference signal received power (L1-RSRP) for one or more candidate cells.

20. A communication system, comprising:
a network device configured to transmit candidate configuration information for layer 1 or layer 2 (L1/L2) trigger mobility, the candidate configuration information at least comprising relevant information of one or more configurations for candidate cell(s); and
a terminal equipment configured to:
receive the candidate configuration information, and
transmit a measurement report for one or more cell(s) included in the candidate cell(s) to the network device.
